(19) United States
(12) Patent Application Publication
(10) Pub. No.: US 2010/0246328 A1
(43) Pub. Date: Sep. 30, 2010

(54) SECURITY EVENT DETECTION, RECOGNITION AND LOCATION SYSTEM

(76) Inventors: Judson Mannon Gudgel, Tulsa, OK (US); Jonathan D. Fairchild, Broken Arrow, OK (US); Martin Alan Moon, Tulsa, OK (US); Reed Jules Oppenheimer, Tulsa, OK (US)

Correspondence Address: Mossman, Kumar & Tyler PC, P.O. Box 421239, Houston, TX, 77242, US

(21) Appl. No.: 12/601,244

(22) PCT Filed: May 21, 2008
(86) PCT No.: PCT/US08/64386

§ 371 Date: May 20, 2010

Related U.S. Application Data
(60) Provisional application No. 60/939,299, filed on May 21, 2007.

(51) Int. Cl. G01S 1/20

(52) U.S. Cl. 367/127

(57) ABSTRACT

A system for detecting the direction of an occurrence of an event from a known point or the location of an event comprising at least two of: a sensor comprising: a microprocessor; a wireless network; an element sensitive to evidence of the event communicating with the microprocessor; and a first Ultra-Wideband Radio module; wherein: the element sensitive to evidence of the event is in communication with the microprocessor allowing the microprocessor to function to detect the event; the first Ultra-Wideband Radio module functions to determine the location of the sensor; the wireless network system allows for the interfacing and sharing of data between the sensor and other components of the system for detecting events; and the system for detecting events functions to multi-laterate the location and time of the event. The use of ultra-wide band radio modules allows for very precise location of events and enhanced communications as compared to conventional systems. It also allows for the correction of GPS locationing and for use inside of structures and other venues where GPS is not effective.

### BACKGROUND OF THE INVENTION

1. Technical Field

The present invention relates to a security event recognition and location system and a method for using same. The present invention particularly relates to such a system and method having high precision as compared to prior art systems.

2. Background of the Art

A few large cities have become plagued with gunfire. This gunfire may be both related and unrelated to the criminal community. For example, gunfire associated with celebrations has been known to cause injury and death. Similarly, gunfire associated with gang activity may be slow to be reported to the authorities resulting in loss of life due to delays in getting medial attention to injured victims

Some of the cities have adopted location systems that have proven effective in the location of the gunfire. Such systems, sometimes referred to as “gunshot detection systems” are generally known and available. Such systems can be used to detect the source of an acoustic event, the radial direction of an event and/or the general proximity of an event.

While useful in civil situation, such systems have obvious utility in martial situations. Sniper fire, for example, may be more effectively suppressed with better intelligence regarding the location of the sniper. Locating hidden heavy weapons positions may also be useful to soldiers in time of war.

### SUMMARY OF THE INVENTION

In one aspect the invention is a system for detecting the direction of an occurrence of an event from a known point or the location of an event comprising at least two of: a sensor comprising: a microprocessor; a wireless network; an element sensitive to evidence of the event communicating with the microprocessor; and a first Ultra-Wideband Radio module; wherein: the element sensitive to evidence of the event is in communication with the microprocessor allowing the microprocessor to function to detect the event; the first Ultra-Wideband Radio module functions to determine the location of the sensor; the wireless network system allows for the interfacing and sharing of data between the sensor and other components of the system for detecting events; and the system for detecting events functions to multi-laterate the location and time of the event.

In another aspect, the invention is a method for determining the direction of an occurrence of an event from a known point comprising: receiving evidence of the occurrence of an event at level sufficient to be detected by a sensor of the invention wherein the evidence is received by at least two such sensors; using at least the difference of the time of arrival of the evidence at the two sensors, determining the direction relative to a known point from which the evidence arrived at the known point.

In still another aspect, the invention is a method for determining the direction of an occurrence of an event from a known point and/or the location of an event comprising: receiving evidence of the occurrence of an event at level sufficient to be detected by a sensor of the invention wherein the evidence is received by at least three of the sensors; and a) using at least the difference in the time of arrival of the evidence at the three sensors, determining the direction relative to a known point from which the evidence arrived at the known point; b) using at least the difference in the time of arrival of the evidence at the three sensors, determining the location of the event; or both a & b.

Another aspect of the invention is a system for monitoring the location within a structure of items, animals, and/or people comprising at least two sensors at least one of which is: a portable sensor comprising: a microprocessor; a wireless network; and a first Ultra-Wideband Radio module wherein: the first Ultra-Wideband Radio module functions to determine the location of the sensor; the wireless network system allows for the interfacing and sharing of data between the portable sensor and other components of the system.

### BRIEF DESCRIPTION OF THE DRAWINGS

The invention is further defined by the accompanying drawings, wherein like numerals refer to like parts throughout, and in which:

FIG. 1 is an illustration of a wrist wearable device for use with the method of the invention;

FIG. 2 is a component perspective view of a sensor useful with the method of the invention;

FIG. 3 is a flow chart showing the process flow for determining the direction of an event using two sensors; and

FIG. 4 is a flow chart showing the process flow for determining the direction of an event using two sensors.

### DETAILED DESCRIPTION OF THE INVENTION

The present invention is a system and method for the detection and location of a security event. For the purposes of the present invention, a security event is an event that can result in the loss of life, the destruction of property, or the disruption of commercial activities; and is of interest to police or military organizations.

The method of the present invention includes determining a time and a location of a security event. The present invention is, in one aspect, an improvement over the prior art which includes the use of ultra-wide band radio modules to increase the precision over that possible with the prior art. Exemplary prior art includes, for example, that disclosed in U.S. Pat. No. 5,973,998 to Showen, et al., which is fully incorporated herein by reference. Another such system is that of the system disclosed in U.S. Pat. No. 6,847,587 to Patterson, et al., which is fully incorporated herein by reference. Still other systems are disclosed in U.S. Pat. Nos. 5,703,835 to Sharkey, et al., and U.S. Pat. No. 5,455,868 to Sergent, et al., which are both fully incorporated herein by reference.

In one embodiment, the invention is a system for detecting the direction of an occurrence of an event from a known point or the location of an event comprising at least two of: a sensor comprising: a microprocessor; a wireless network; an element sensitive to evidence of the event communicating with the microprocessor; and a first Ultra-Wideband Radio module; wherein: the element sensitive to evidence of the event is in communication with the microprocessor allowing the microprocessor to function to detect the event; the first Ultra-Wideband Radio module functions to determine the location of the sensor; the wireless network system allows for the interfacing and sharing of data between the sensor and other components of the system for detecting events; and the system for detecting events functions to multi-laterate the location and time of the event.

The sensor of the invention includes a microprocessor. It should be noted that the terms employed in the discussion of the preferred embodiments are to be given their broadest meaning. For example, the term “processor” is intended to be interpreted broadly and to describe programmable devices, including but not limited to microcontrollers, risk processors, ARM processors, digital signal processors, logic arrays, and the like. The processors perform several functions, one of which is recognition of the type of event that has occurred.

The sensors of the present invention include a wireless network. The wireless network functions to allow the sensors to communicate with each other and, in some embodiments with a central processor as well. In some embodiments, the wireless network is a conventional wireless network and in other embodiments, the wireless network incorporates an ultra-wide band radio module.

In the practice of the invention, the sensors include an element sensitive to the occurrence of an event. Such an element may be a sound transducer, but it may also be an accelerometer, a seismometer, a hydrophone, a radiation detector, a biohazard detector, a gas detector and combinations thereof. The type of element will dictate how it is used. For example, a hydrophone will need to be placed into water while a seismometer will need to be placed into contact with the ground or a fixed support in contact with the ground.

In one embodiment, the element sensitive to an event is a sound transducer array. In this embodiment, there are two or more audio channels. Each audio channel is buffered. Each channel has a different gain setting. The processor monitors the highest sensitivity audio channel for events. In some embodiments, if a channel is over-driven (clipped), software examines the next less sensitive channel including the data that was buffered when the clip occurred. This process can be repeated, stepping to the next less sensitive channel, until a channel is found that hasn't clipped yet which contains the most complete data for pattern and/or other recognition purposes. One advantage of the sound transducer array is that all channels can then be used for calculating time difference of arrival to determine direction and or exact location of the event.

Another element of the sensors of the invention is an ultra-wide band radio module. These modules incorporate ultra-wide band radio technology modules that operate in the in 3.1-10.6 GHz range. These modules function within the sensors of the invention to: determine the location of each sensor; determine the timing reference for time difference of arrival calculations; and wireless communications of both equipment and operators.

In one embodiment of the invention, at least one of the sensors will include a GPS module. In another embodiment, all of the sensors will include a GPS module. One advantage of the present invention is that the ultra-wide band radio modules allow for a much more precise determination of the location of each sensor relative to every other sensor than is possible by the use of a GPS system, even one incorporating a WAAS signal. The global positioning of a network of the sensors of the present invention is enhanced when the GPS positioning of each sensor is rationalized against the position of each sensor relative to every other sensor as determined using the ultra-wide band radio modules. In one embodiment of the invention, this would allow for a much more precise location of an event and, when the event is a security event such as a gunshot, a response with precision ordinance or sniper fire.

In one embodiment of the invention, the sensor includes a digital compass to assist with direction finding and other activities. In another embodiment, the sensors include an accelerometer to allow for the processor to ignore or modify results that could be impaired by motion of the sensor.

When there are only two sensors in position to receive evidence of an event, then while it may not be possible to multi- or tri-laterate the event, the system of the invention may be used to determine the direction of the event. When at least three sensors are present, the time difference of arrival of the evidence of the event may be used to calculate the position of the event relative to the any sensor and that in turn combined with GPS data to determine the global position of the event. The time of the event may be estimated with a high degree of accuracy based upon event recognition by the processor.

The system of the invention may, in some embodiments, may be used with more than three sensors. When more than three sensors are present, the system may be used in at least two ways to multi-laterate an event. In a first mode, the groups of three sensors may be used to cross check the projected location of an event. When less than six sensors are present, multiple multi-laterations may still be done. For example, when only 4 sensors are present, a first tri-lateration may be performed using sensors 1, 2, and 3. A second tri-lateration may be performed using sensors 1, 2, and 4. A third tri-lateration may be performed using sensors 1, 3, and 4. Any combination of 3 of the four sensors may be used to perform a tri-lateration.

In an alternative embodiment, all of the sensors present within the detection range of an event may be used to perform a multi-lateration. Filtering may be implemented to ignore or at least give less weight to sensors that are either too near or too far from the event. In still another embodiment, additional filtering may be implemented where other kinds of interference is present, such as when a sensor is located within a structure subject to reverberation. Such filtering may be useful where there are too many sensors within range of an event. In such an embodiment, an optimum number of sensors in optimum location may be selected and used within the multi-lateration algorithm.

In one embodiment, very small sensors may be placed upon a single person, with placement optimized to allow for multi-lateralization. For example, a sensor may be place upon both wrists, upon boots, and even a helmet to maximize separation to increase accuracy.

In one embodiment of the invention, some or even all of the sensors would be portable such that they may be worn by a soldier or law enforcement officer or mounted on a vehicle or a robot such as an ordinance disposal robot or a weapons bearing robot. Other components may also be portable, but of a lesser degree. For example, a larger component may be carried as in the case of a squad leader carrying a central processor for facilitating networking and data sharing. Preferable, all of the equipment necessary for a user to take offensive or defensive actions would be sufficiently portable to be wearable. In such a preferred embodiment, the wearable components would include: a microphone for receiving acoustic events; an amplifier and possibly other signal conditioning circuitry; a processor, typically a digital signal processor, having an analog to digital converter; a GPS receiver and its associated antenna; and an interface for communicating via a communication network.

In one preferred embodiment of the invention, a sensor may be incorporated into a “wristwatch” like housing which can be worn strapped to the users' wrist and, in an alternative embodiment the sensor may additionally output current time thus serving a dual function. The GPS and communication antennae may be housed internally or incorporated in a watchband. Additional elements of a wrist worn sensor may include manual controls to allow scrolling through display screens and to allow the mode of operation to be changed; a windscreen or other device to reduce wind noise received by sensor and protect the microphone from weather and from minor impacts. In one preferred embodiment, the sensor has an exterior color which will blend with the soldier's uniform and/or the environment and thus not compromise camouflaging. In still another alternative embodiment, the wrist worn system would house a host system. In such a configuration, a display could be used to display the location of any soldier in the squad, historical details, receive messages up and down the chain of command, as well as display current shooter information when the squad is fired upon.

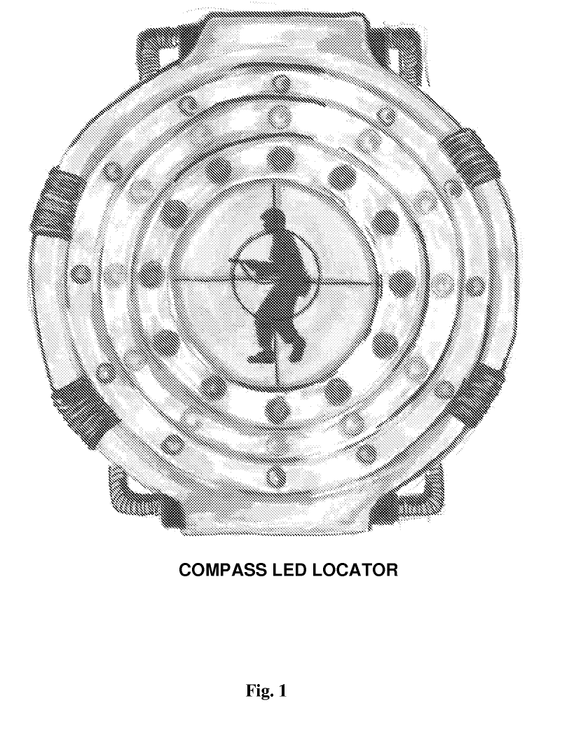

In one embodiment of the invention, a device that may be worn on the wrist and that communicates with each sensor of the invention may be used. This embodiment is illustrated in FIG. 1. Such devices may include: a microprocessor; an LCD screen for display; an array of LED's pointing to the event as illustrated in FIG. 1; a GPS Module; an Accelerometer; and a magnetometer.

In an alternative embodiment, the sensors may be in communication with a microprocessor not located within a sensor. For the purposes of this application, such a processor may, in some embodiments, be a host system dedicated to this function. In other embodiments, this may be a function designed into the sensors to broadcast to any processor within range and able to receive such intelligence.

This external processor may interact with sensors to send event direction and/or location information to other devices. For example, in one embodiment, personnel not having a sensor may receive information on the location of a gunshot via normal communication channels such as a radio or a cell phone.

In the practice of the invention, once an event is detected, it may be desirable for a response to the event to occur. When the event is a security event, then that response may include whatever degree of force that is practical in view of the circumstance extant at the time of the event.

In one embodiment of the invention, the sensors of the invention may be used to monitor the location of items, animals or people within a structure. The sensors of the present invention are not dependent upon GPS which may not be functional or sufficiently accurate to, for example, find someone in a structure that is on fire, engulfed with smoke, or collapsed due to flood or earthquake. It follows then that the system of the invention could be very useful in applications including firefighting, other emergency response, finding lost hikers or skiers, finding divers, finding submerged vehicles and the like.

The communication systems useful with the present invention include, but are not limited to: a digital radio link; infrared; wireless Ethernet; Bluetooth; and the like. Preferably, such a link is of minimal power and transmits intermittently to avoid detection by opposing forces.

The sensors of the invention include a power supply, such as a battery. In a preferred embodiment, the power supply is integrated into the sensor.

The sensor of the invention may also include an interface for accessing other systems. In one embodiment, the interface is configured to interface an Ethernet interface.

It should also be noted that while preferred embodiments of the present invention have been described in connection with gunshot location systems, the techniques for providing a convenient means for equipping a soldier or police officer with a wearable gunshot detection sensor can be applied to other types of systems, such as those monitoring health conditions, environmental conditions, and the like. For example, a patient alarm of a falling patient may be detected in a medical care facility.

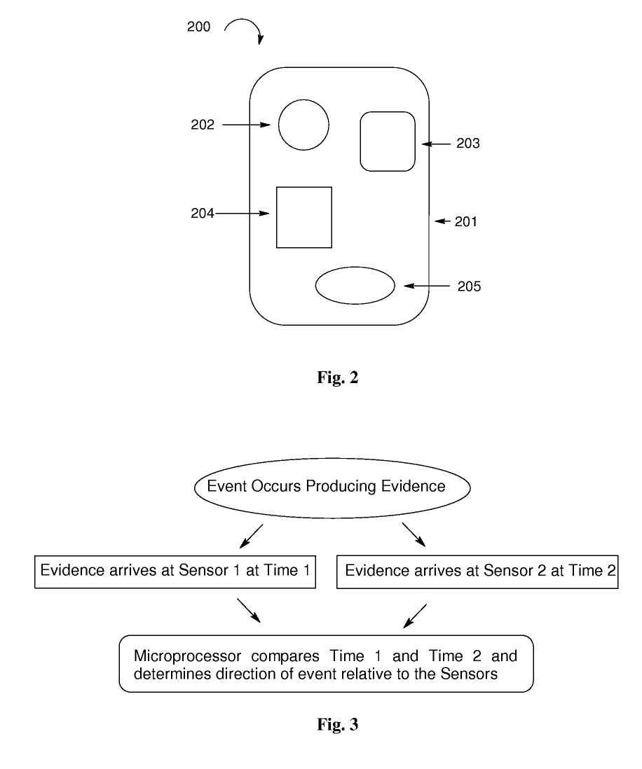

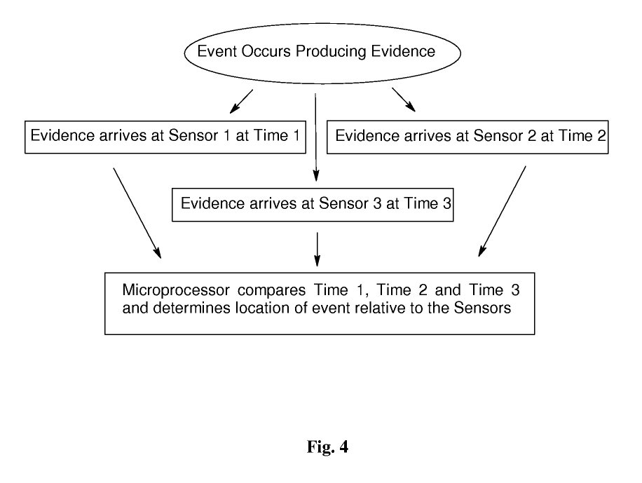

Turning now to the remaining figures, FIG. 2 is component level perspective a sensor 200 useful with the method of the invention. In this figure, 201 is a case or enclosure; 202 is a microprocessor; 203 is a wireless network receiver/transmitter; 204 is an element sensitive to evidence of an event; and 205 is an Ultra-Wideband Radio module. All of the modules may be located within or on the case. The case may also include other elements discussed but not shown, such as a GPS transceiver, a battery and the like.

FIG. 2 and FIG. 3 are flowcharts. FIG. 2 illustrates determining direction using 2 sensors. FIG. 3 illustrates determining direction using 3 sensors.

The following example is provided to more fully illustrate the invention. As such, it is intended to be merely illustrative and should not be construed as being limitative of the scope of the invention in any way. Those skilled in the art will appreciate that modifications may be made to the invention as described without altering its scope.

### EXAMPLES

### Hypothetical Example 1

A sniper fires at a member of a squad of soldiers. At least two of the soldiers in the squad are wearing sensors of the invention. The report from the snipers weapon is received at the two sensors, the audio signal is conditioned and digitized and processed to detect the gunshot. Upon detecting a gunshot, a time of arrival and sensor position are obtained from a GPS receiver and transmitted to a host system. The direction of the sniper at the time of the attack is transmitted to the squad whereupon some members take cover and other members take actions to neutralize the sniper.

### Hypothetical Example 1A

Hypothetical Example 1 is repeated substantially identically except that the sensor does not communicate with a host system and instead communicated directly with the other sensors, performs necessary calculations onboard the sensor, and then transmits the intelligence directly to squad.

### Hypothetical Example 2

Example 1 is repeated but this time there are at least three sensors present and the location of the sniper is multi-lateralized. Precision return fire is performed using a mobile gun platform robot have mounted thereon a sniper rifle.

### Hypothetical Example 3

A fire engulfs a large building. Sensors of the present invention are used by firefighters entering the building. One fireman is overcome by smoke. Another firefighter uses a led wrist device of the invention to find the overcome firefighter and effect a rescue.

### Hypothetical Example 4

An event occurs producing a loud noise, such as a gunshot. Within range of the report of the gunshot are two sensors. Each of the sensors includes a microprocessor; a wireless network; an ultrasonic transceiver a GPS module; an element sensitive to evidence of the event; in this case a microphone, communicating with the microprocessor; and an ultrasonic transceiver. The microphone is in communication with the microprocessor allowing the microprocessor to function to detect the event.

Both sensors emit an ultrasonic tone via the ultrasonic transceiver while simultaneously sending a message via the wireless network with a unique sensor identification and the exact GPS time and details of the tone, frequency and length of the tone transmitted. Each sensor in the system will receive the tone and message; and each sensor will calculate an exact distance between each sensor based on time of arrival. The wireless network system allows for the interfacing and sharing of data between the sensor and other components of the system for detecting events. Thus the system for detecting events functions to multi-laterate the precise location and time of the gunshot.

### Hypothetical Example 5

An event occurs producing a loud noise, such as a gunshot. Within range of the report of the gunshot are five sensors. Each of the sensors includes a microprocessor; a wireless network; an ultrasonic transceiver a GPS module; an element sensitive to evidence of the event; in this case a microphone, communicating with the microprocessor; and an ultrasonic transceiver. The microphone is in communication with the microprocessor allowing the microprocessor to function to detect the event.

All five sensors emit an ultrasonic tone via the ultrasonic transceiver while simultaneously sending a message via the wireless network with a unique sensor identification and the exact GPS time and details of the tone, frequency and length of the tone transmitted. Each sensor in the system will receive the tone and message; and each sensor will calculate an exact distance between each sensor based on time of arrival. The wireless network system allows for the interfacing and sharing of data between the sensor and other components of the system for detecting events.

The system produces three calculations regarding the location of the gunshot. The first calculation is made using sensors 1, 2, and 3. The second calculation is made using sensors 1, 4 and 5. The third calculation is made using sensors 3, 4 and 5. The three locations are compared a location equidistant from the three calculations is reported as the location of the gunshot. Thus the system for detecting events functions to multi-laterate the precise location and time of the gunshot.

### Hypothetical Example 6

The gunshot of Hypothetical Example 5 occurs on a target range during training exercises and the sensors are located on test subjects and/or vehicles. The sensors are further used to record the movement and actions of each such test subject and/or vehicle and the recording is used for training purposes.

What is claimed is:

1. A system for detecting the direction of an occurrence of an event from a known point or the location of an event comprising at least two sensors, the sensors comprising:
a microprocessor; a wireless network; an element sensitive to evidence of the event communicating with the microprocessor; and a first Ultra-Wideband Radio module;
wherein:
the element sensitive to evidence of the event is in communication with the microprocessor allowing the microprocessor to function to detect the event;
the first Ultra-Wideband Radio module functions to determine the location of the sensor; and
the wireless network system allows for the interfacing and sharing of data between the sensor and other components of the system for detecting events; and the system for detecting events functions to multi-laterate the location and time of the event.

2. The system of claim 1 wherein the sensors additionally comprise a battery, GPS module, a external interface, and a case.

3. The system of claim 1 and wherein the system may be used to monitor the location within a structure of items, animals, and/or people wherein at least one of the sensors is portable and is on or near the items, animals, and/or people.

4. The system of claim 1 further comprising a wrist display.

5. A method for determining the direction of an occurrence of an event from a known point comprising:
receiving evidence of the occurrence of an event by at least two sensors at a level sufficient to be detected by the sensor;
using at least the difference of the time of arrival of the evidence at the two sensors to determine the direction relative to a known point from which the evidence arrived;
wherein the sensor comprises a microprocessor; a wireless network; an element sensitive to evidence of the event communicating with the microprocessor; and a first Ultra-Wideband Radio module.

6. The method of claim 5 wherein the event is a gunshot or explosion.

7. The method of claim 5 wherein the evidence is received by at least three of the sensors; and
a) using at least the difference in the time of arrival of the evidence at the three sensors, determining the direction relative to a known point from which the evidence arrived;
b) using at least the difference in the time of arrival of the evidence at the three sensors, determining the location of the event; or
c) using at least the difference in the time of arrival of the evidence at the three sensors, determining the direction relative to a known point from which the evidence arrived; and determining the location of the event.

8. The method of claim 7 wherein there are at least 6 sensors and at least two determinations are made using to separate groups of 3 sensors.

9. The method of claim 7 wherein there are multiple determinations made using overlapping but unique groups of sensors.

10. The method of claim 7 wherein the sensors are used to record the location of each sensor at the time of the event and subsequent movements and actions of a test subject or vehicle with which the sensor is associated and the recording is used for training purposes.

11. A method for determining or monitoring the location within a structure of items, animals, and/or people wherein the items, animals, and/or people are associated with a sensor, and the sensor is a portable sensor comprising:
a microprocessor; a wireless network; an element sensitive to evidence of the event communicating with the microprocessor; and a first Ultra-Wideband Radio module.
